(19) United States
(12) Patent Application Publication
(10) Pub. No.: US 2018/0010572 A1
(43) Pub. Date: Jan. 11, 2018

(54) ROTARY AIDED CONJUNCTIVE ENERGY SYSTEM

(71) Applicant: ROBERT B. LOMERSON, FORT WORTH, TX (US)

(72) Inventor: ROBERT B. LOMERSON, FORT WORTH, TX (US)

(21) Appl. No.: 15/521,183

(22) PCT Filed: Apr. 25, 2016
(86) PCT No.: PCT/US2016/029255

§ 371 Date: Apr. 21, 2017

Related U.S. Application Data
(60) Provisional application No. 62/151,827, filed on Apr. 23, 2015.

(51) Int. Cl. F03B 17/04; H01F 7/02; F03B 15/02

(52) U.S. Cl. CPC F03B 17/04; F03B 15/02; H01F 7/0242; F05B 2240/40; F05B 2210/18; F05B 2240/60; F05B 2260/60; F05B 2240/57

(57) ABSTRACT

The present application includes a system for generating energy via a rotating drum. The system includes a housing, a drum, and a plurality of enclosed chambers. The housing surrounds the drum and helps to distinguish between a gravitational domain and a buoyancy domain. The drum is coupled to a shaft and configured to rotate within the housing about a central axis. The plurality of enclosed chambers are radially aligned around an internal surface of the drum. The drum is exposed to a gravitational domain and a buoyancy domain simultaneously so as to induce rotation of the drum around the shaft. The enclosed chambers are subjected to gravitational forces in the gravitational domain and the enclosed chambers are subjected to buoyancy forces in the buoyancy domain.

### TECHNICAL FIELD

The present application relates generally to power generation and, more specifically, to a system for producing power by capturing in a complimentary fashion the opposing forces of gravity and buoyancy, which can be further enhanced by water/fluid seeking its own level, water taking the path of least resistance, and inertia.

### DESCRIPTION OF THE PRIOR ART

Throughout history, numerous methods to generate electrical power to yield work have been conceived, and even fewer developed. The success, or efficacy of a particular technology depends largely on the ability to overcome forces of nature, such as heat and friction, or to mitigate one or the other of forces tending toward equilibrium, so that ample power production can take place. More recently, environmental concerns have been thrust into the mix so that less effective technologies are becoming serious alternatives.

Thermal engines are the most common source of power generation today. The two primary types are nuclear and fossil-fuel-driven engines that produce power by burning a fuel or using fusion to heat steam to drive a turbine. Fossil-fuel-driven engines can also provide power by burning the fuel resulting in a controlled explosion, such as used in a vehicle. Either way, a thermal heat engine requires a continuous supply of expendable fuel (i.e. coal, oil, gas, wood, uranium, etc.) that must be produced, processed, and transported to the point of use, and finally, the numerous effluents properly disposed of. Regardless of the specific generation method, enormous volumes of water are consumed, and subsequently, vast quantities of residual heat are released into the atmosphere. In the case of fossil-fuels, CO2, GHG's (greenhouse gases), and effluents are also a by-product. These residues and effluents must also be controlled and properly disposed of since they are often hazardous.

Other types of engines are known. Limited resources may restrict the type of engines for use in different areas. Additionally, for each type of engine, various energy losses are experienced, contributing to varied, but significant generation inefficiencies.

Although great strides have been made over the years in power generation, an improved method of generating power that is independent of fuel or water constraints, has full cycle generation capacity, and can feasibly operate independently.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIGS. 1A and 1B are a cross-sectional side view and a cross-sectional end view, respectively, of a rotating drum according to an embodiment of the present application;

FIGS. 2A and 2B are a cross-sectional side view and a cross-sectional end view, respectively, of a system with the rotating drum of FIGS. 1A and 1B within a tank;

FIG. 3 is a cross-sectional side view of a system with the rotating drum of FIG. 1 within a sealed housing; and

FIG. 4 is a cross-sectional side view of the system of FIG. 3 having both a siphon tower and an enlarged heavy density fluid column reservoir;

FIG. 5 is a side view of a first exemplary configuration using the drum of FIGS. 1A and 1B;

FIG. 6 is a side view of a second exemplary configuration using the drum of FIGS. 1A and 1B; and

FIG. 7 is a cross-sectional side view of the drum of FIGS. 1A and 1B aided with the assistance of a magnetic power amplification system.

While the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms, such as above and below, to describe a spatial relationship between various components or to describe the spatial orientation of aspects of such components should be understood to describe a relative relationship between the components or a spatial orientation of aspects of such components, respectively, as the device described herein may be oriented in any desired direction.

The method of use in accordance with the present application overcomes one or more of the above-discussed problems commonly associated with existing power generation. Specifically, the system of the present application is configured to effectively produce a continuous power source by capturing both the gravitational forces and the buoyancy forces acting together on a body, and enhancing the lift in the buoyancy domain by capitalizing on the fact that “water will seek the same level.” This novel approach markedly increases efficiency as it utilizes the entire generation cycle. These and other unique features of the system are discussed below and illustrated in the accompanying drawings.

The system will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein the rotary aided conjunctive energy system of the present application is illustrated. The system of the present application includes a rotating drum body 103 having a plurality of enclosed chambers 105 spaced around a central axis or shaft 113. The rotation of the drum results from a combination of the effects of gravitational forces and buoyancy forces stemming from the phenomenon of water seeking its own level and water taking the path of least resistance. These forces act upon a number of individually spaced chambers 105 (cylindrical in this embodiment) within the drum body 103. It is preferred that there is an odd number of chambers 105 to assist in maintaining rotation. This avoids situations where each chamber 105 has an equal and opposite mass (chamber) opposite itself in the drum. Approximately half of the total mass of the odd-numbered bodies within the drum body are subjected to gravitational forces, while the other half are subjected at any one time to buoyancy forces or forces from water seeking its own level. Gravitational forces act to pull “down” the chambers 105 while buoyancy forces and forces from water seeking its own level act to elevate the other chambers 105 resulting in a continuous energy producing cycle.

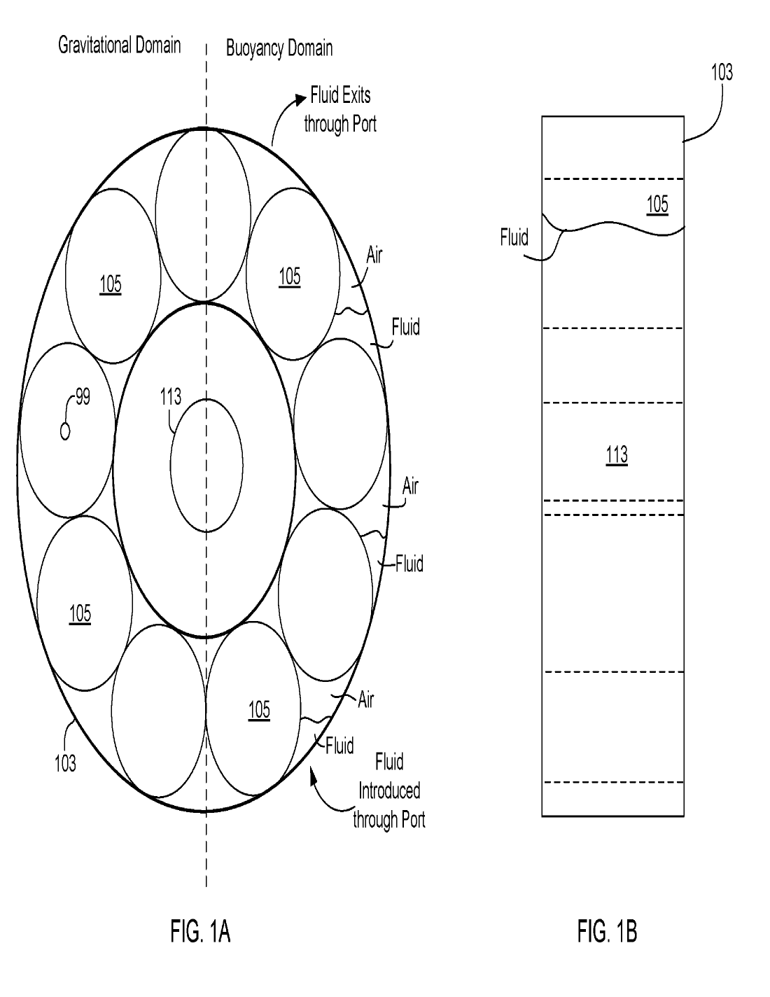

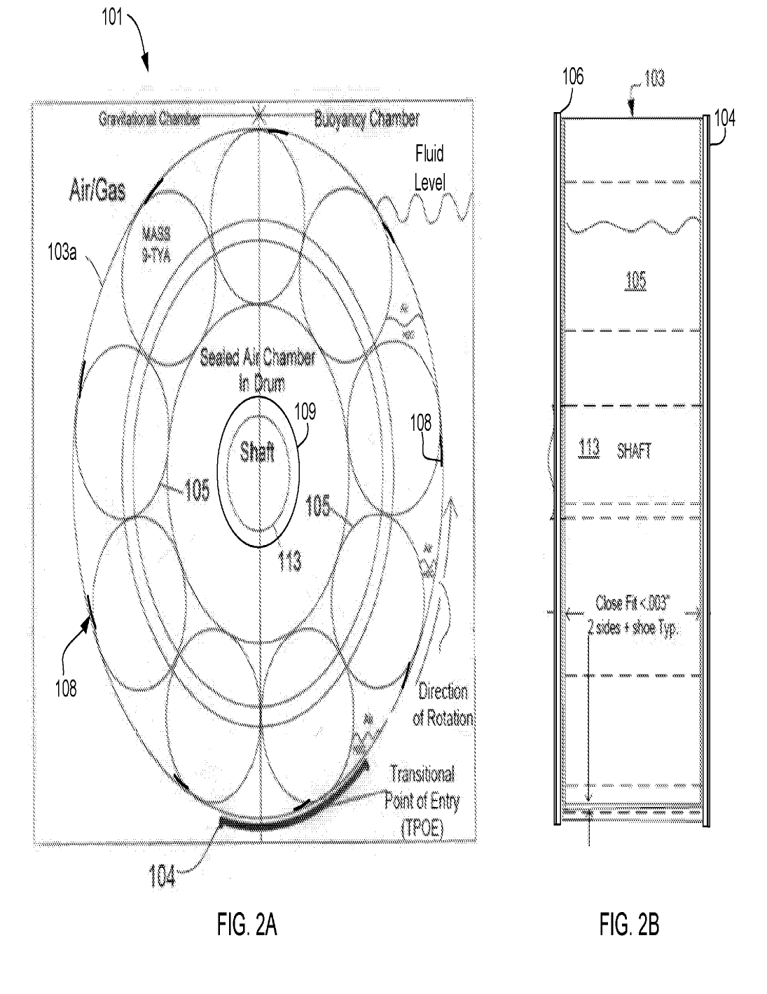

In FIG. 1A a side cross-sectional view of drum 103 is illustrated. Drum 103 is coupled to shaft 113 and configured to rotate within a housing (see FIGS. 2-6) or tank about a central axis. The central axis is concentric with shaft 113. A plurality of enclosed chambers 105 are selectively located in a radial fashion around an outer-most internal position within drum 105. As stated previously, it is desired that there are an odd number of chambers 105. In the various embodiments and methods or ways of using drum 103 as seen in the later Figures, drum 103 is in general exposed to a gravitational domain and a buoyancy domain simultaneously so as to induce rotation of the drum 103 around the shaft 113. The enclosed chambers 105 are subjected to gravitational forces in the gravitational domain and the enclosed chambers 105 are subjected to buoyancy forces in the buoyancy domain. Chambers 105 are filled with a ratio of fluid and air. Such ratio may be adjusted through a port 99. Other substances may be used to fill chamber 105. Although depicted on a single chamber, it is understood that each chamber may include port 99. It is important to note that the gravitational forces and buoyancy forces are exerted upon separate enclosed chambers within the drum simultaneously so as to maintain a direction of rotation. The following discussion and Figures will illustrate one or more methods and ways such drum 103 may be used to generate energy

For reference purposes, the following terms are herein defined:
RCE: Rotary Conjunctive Energy
RACE: Rotary Aided Conjunctive Engery
TPOE: transitional point of entry—entry port for the water to engage the chambers in the buoyancy domain
SIBC: self-inflating buoyancy cover
buoyant intrusives: any particle, object, substance, or mass that acts to lower the density of fluid when inserted into any give fluid volume
WSOL: Water seeking own level
WSPOLR: Water seeking path of least resistance

Referring now to FIGS. 2A and 2B in the drawings, a cross-sectional and side view of a rotating drum within a rotary conjunctive energy (RCE) system 101 is illustrated. The rotating drum 103a is located within a tank/housing 102 and are representative of the RCE concept. Drum 103a is similar in form and function to that of drum 103 except for the inclusion of a plate and seals mentioned later. This concept utilizes only gravity and buoyancy and consists of a partition within a tank to define the two domains. Seal 104 (also known as wipers and “shoes”), in conjunction with equal pressurization of both chambers, might be used to prevent the liquid from moving from the buoyant domain back into the gravity domain at the transitional point of entry (TPOE). It is necessary that seal 104 be located intimately at the sides and base of the rotating drum 103 so as to prevent or substantially mitigate the liquid from moving from the buoyant (liquid) domain back into the gravity (air) domain, particularly at the transitional point of entry (TPOE);

The RCE system 101 provides a continual direct source of power by utilizing gravitational force in conjunction with an opposite anti gravitational buoyant force. The mechanism described consists of a number of chambers 105 arranged along the periphery and bonded at either end to two parallel circular plates 106 to create a drum 103a. Bonding of these chambers to each other along their peripheral contact points creates an enclosed positively buoyant sealed air volume. Each chamber 105 contains a sufficient amount of a substance fluid (generally water) such that the chambers 105 achieve a slight positive buoyancy. Buoyancy of the individual chamber is further enhanced by the attachment of self-inflating buoyancy covers (SIBCs) 108, open rearward facing air chambers created by curvilinear plates bonded at both ends to the outer drum plates 106 and at the forward edge to the outermost periphery of each chamber 105 and may utilize permanent foam in place of the water normally captured. SIBCs 108 also serve to provide a close interface with the “shoe” 104 (or seal) to further restrict the entrance of unwanted water into the gravitational domain.

Drum 103 is coupled to a horizontal central axle 113 with a one way CCW ratchet 109 used for both structural and drum/system support and to facilitate for the extraction of power from the rotating drum. The axle 113 is positioned in the chamber at a level equal to the radius of the rotating drum below the buoyancy domain surface, and longitudinally along the interface between two separate chambers one containing air, the other a liquid (water). A one-way CCW ratchet 109 is affixed to the central axle 113 to ensure no undesired reverse movement of the revolving drum occurs. The fluid in the buoyant chamber is prevented from escaping by close-fitting/high tolerance interfaces parallel to the drum end plates with wipers 107 lightly contacting said drum, and in conjunction with capillary force and the sweeping rotary action of the drum. Similarly, a close-fitting curved plate “shoe” 104 that extends from the lower chamber interface past the TPOE and mates closely with the perimeter of the drum and SIBC covers and contains openings as required for the controlled ingress and egress of water into and out of the SIBC's.

Any water escaping form the fluid chamber will accumulate at the bottom of the gravity chamber and will be reintroduced into the fluid chamber aided by inertia and the capillary sweeping action of the drum. A one-way spring loaded ratchet prevents any counter rotation of the drum. If necessary, a spring action could be employed to assist in forcing the drum to rotate in the proper direction CCW. Other additional forces such as inertia (flywheel), a pulsed electromagnetic, or electrical booster can be utilized to ensure a smooth transition from the gravity (air) chamber to the base of the buoyancy (fluid) chamber known as the transitional point of entry (TPOE) or just past the point where the positively buoyant cylinders enter the fluid chamber (buoyancy domain).

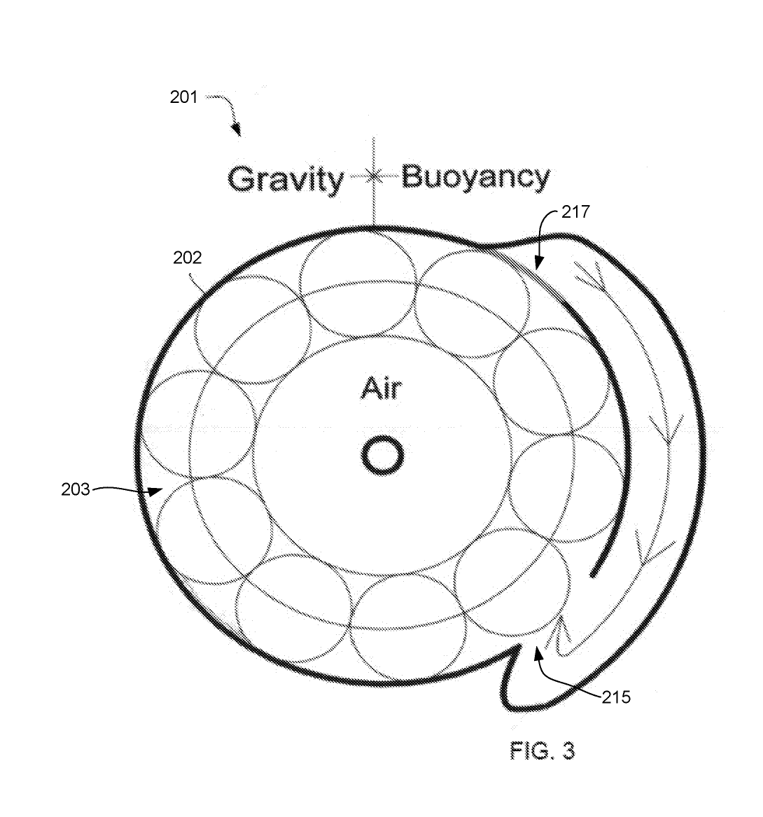

Referring now also to FIG. 3 in the drawings, a cross-sectional end view of the rotating drum 103 within a totally enclosed container is illustrated. System 201 uses a totally enclosed housing 202 that now eliminates the requirement for a gravity/buoyancy tank and any possibility of the liquid/water within the buoyancy domain transitioning back to the gravity domain. This is a major improvement over the RCE system of FIGS. 2a and 2B. System 201 is referred to as a RACE (Rotary-Aided Conjunctive Energy) system 201 and adds the powerful concepts of water/liquids seeking their own level and taking the path of least resistance to that of gravity and buoyancy.

This modification from RCE 101 to RACE 201 introduces the concept of water level and forced differentials to drive the same rotary drum/axle assembly previously described, but replaces the two chambered container with a single totally encompassing, sealed close-fitting housing 202 that includes both a gravity and a buoyant domain with two openings (ports): a buoyant domain with a fluid/liquid input 215 near the base, and an output 217 for the same near the top of a contained fluid column.

Pure water has a constant weight of 62.4 pounds per cubic foot but will weigh much less when it contains a number of positively “buoyant intrusives” since they displace the heavier liquid and results in a lower overall density. This yields a volume of fluid that has a lighter weight for a given volume. For instance, a mass A of a 9 inch piece of schedule 20 PVC pipe with two end caps weighs 155 g but sealed with two end caps and containing approximately 10 ounces of water now weighs 422 g. Mass B, an identical empty pipe with caps also weighs 155 g. However, when six buoyant ping-pong balls are placed in a pipe and is filled to the same level with water as a Mass A, it only weighs 275 g. When these pipes are immersed in water Mass A immediately sinks to the bottom of the tank of water whereas Mass B floats vertically with approximately ⅓ of its length above water. This effectively demonstrates the weight difference between pure water and water with positively “buoyant intrusives.” The same principle provides the differential weight/force required to rotate drum 103/203 from the lower point of water entry (TPOE) to the upper point of water exit. In this case the positively buoyant cylinders in conjunction with the “SIBCs” continually provide the “buoyant intrusives” as the drum rotates.

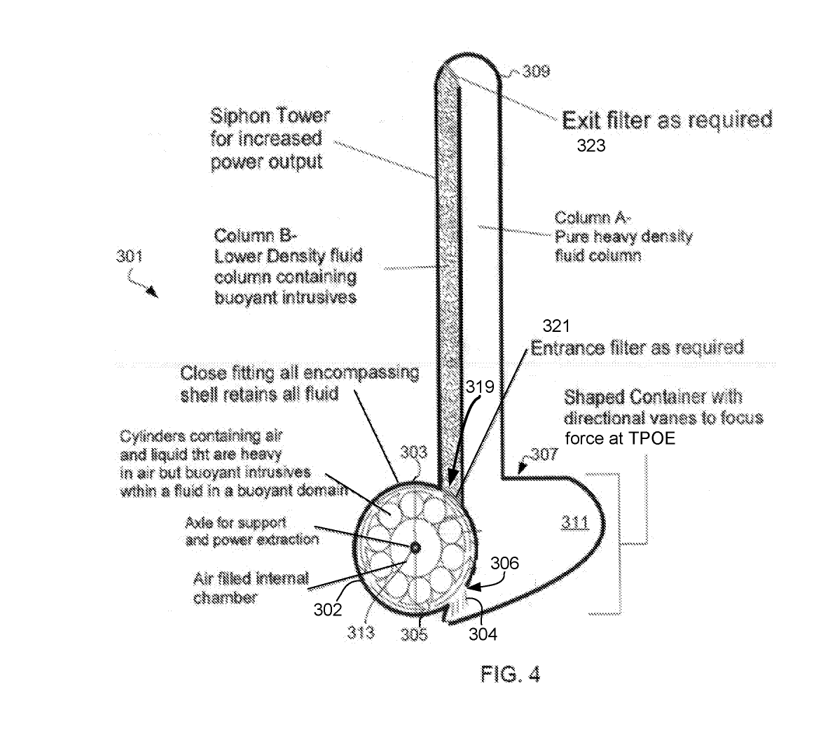

Referring now also to FIG. 4 in the drawings, a cross-sectional view of a further advancement in the RACE system is illustrated. System 201 is modified to generate RACE system 301. This system adds both a siphon tower 309 and an enlarged heavy density fluid column reservoir to increase the hydraulic force at the entrance 306 (TPOE) to the lower density light water column is illustrated. System 301 includes a rotating drum body 303 (similar in form and function to that of drums 103 & 203) having an unequal plurality of masses 305. Masses 305 are coupled to a portion of drum 303 in a circular configuration as seen clearly in the preceding Figures. A close-fitting sealed housing 302 is in communication with the drum body 303 and includes a close-cycle system siphon (CCSS) tower portion 309 and a tank portion 311. System 301 is configured to simultaneously use gravitational forces, buoyancy forces, and water seeking its own level/path of least resistance (WSOL & WSPOLR), and inertia to generate a rotational force on drum 303. It is understood that the particular configuration may be altered and is not limited to a circular configuration as depicted in the drawings. An optional directional vane 304 configured to direct the flow of fluid into the drum may be used.

Masses 305 include an internal weight substance (i.e., liquid) that is also optimized so that the trade-off between maximum buoyancy is achieved when subjected to a liquid, but also so that its mass component contributes significantly to the rotational torque output. Masses 305 are distributed as seen in the previous figures. In operation, the masses 305 are configured to pass between a “dry” environment (gravitational domain) where they are subjected to ambient air and gravitational forces only and a “wet” environment (buoyancy domain) where they are subjected to buoyancy forces, being partially submerged in a fluid. At a lower right portion of drum body 303 is a transitional point of lower entry (TPOE) for liquid to enter a portion of drum body 303. This TPOE is an entrance port 306. At this location, masses 305 adjacent the TPOE are introduced to buoyancy forces. The buoyancy forces provide a force sufficient to raise the masses. At the upper portion of siphon tower 309, after raising the masses, the liquid is released into column A through an output and said liquid then recirculates back to column B. The masses then move past the vertical plane and enter a dry environment where gravity acts upon the masses forcing them down. By incorporating an unequal plurality of equally spaced masses 305 about central shaft 313, masses 305 produce a rotational force on shaft 313 and generate power. It is preferred that an odd number of masses 305 are utilized to avoid a situation where complete symmetry between the gravitational and buoyancy forces result in a net cancellation of forces and the cessation of rotation of drum body 303 as noted in the previous disclosure.

With respect to fluid housing 307, housing 307 is coupled to drum body 303 and is configured to provide a supply of fluid for the buoyancy force. In siphon tower 309, a filter 321 (entrance filter) is used at the lowest point, or the location where the liquid exits the drum body 303 through an outlet port 319. A second filter 323 (exit filter) is located at an upper portion of the siphon tower 309. Between the two filters is a first density fluid while tank 311 includes a second density liquid. The terminology related to what appears to be two separate liquids is not limiting. The two liquids may be different but is not necessary. The first density liquid may include one or more objects and/or “buoyant intrusives” to create a lower density than the second density liquid within tank 311. Therefore, such “buoyant intrusives” may alter the density of the liquid in the different areas despite that the same liquid is used. In such cases, the filters are used to retain the “buoyant intrusives” within a particular region. An example of the difference in densities can be that of a factor of two.

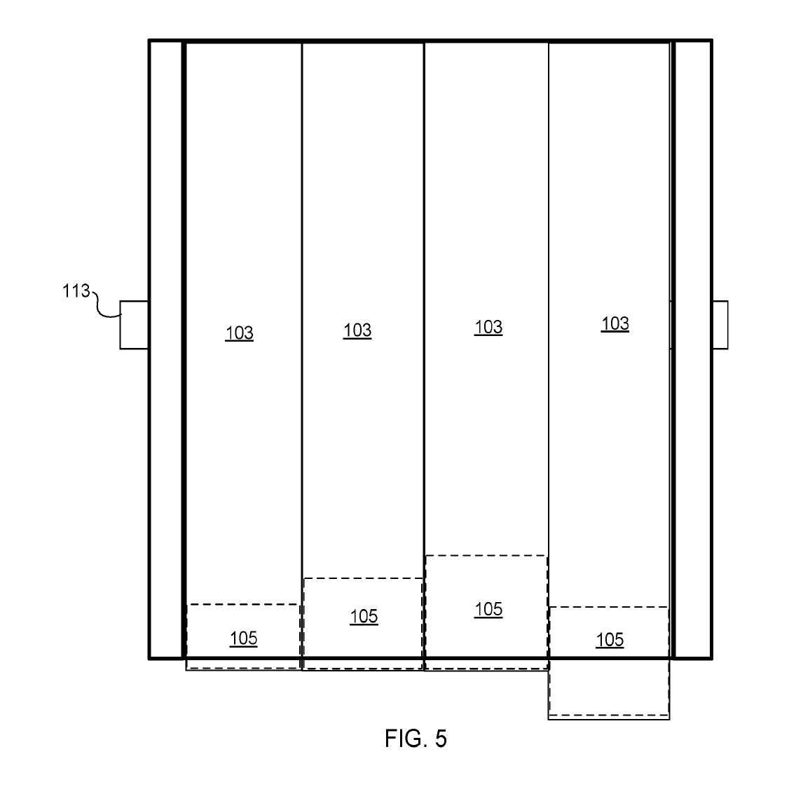

Referring now also to FIG. 5 in the drawings, is a side view of a first exemplary configuration using the drum of FIGS. 1A and 1B is illustrated. FIG. 5 illustrates a plurality of drums 103 concentrically aligned about shaft 113. Each drum is lined up next to the other such that they all operate together to induce rotation of the shaft. It is understood that each drum may be clocked or angularly indexed differently from that of a neighboring drum wherein the chambers 105 of each drum are at a different radial location about shaft 113. Although the masses 105 appear to be staggered at different distances from shaft (axle) 113, masses 105 are illustrated as being represented at different rotational points around drum 103, therefore when viewed from an overhead perspective appear to be at different distances from shaft 113. By staggering the location of a series of masses 105 around the periphery of drum 103, a more continuous torque is applied to the body as a whole, resulting in a smoother operation. It is also understood that the size of drums 103 may be varied such that each has a different diameter (see furthest right drum) so as to vary the amount of torque generated around shaft 113. These configurations can help to provide a more constant torque.

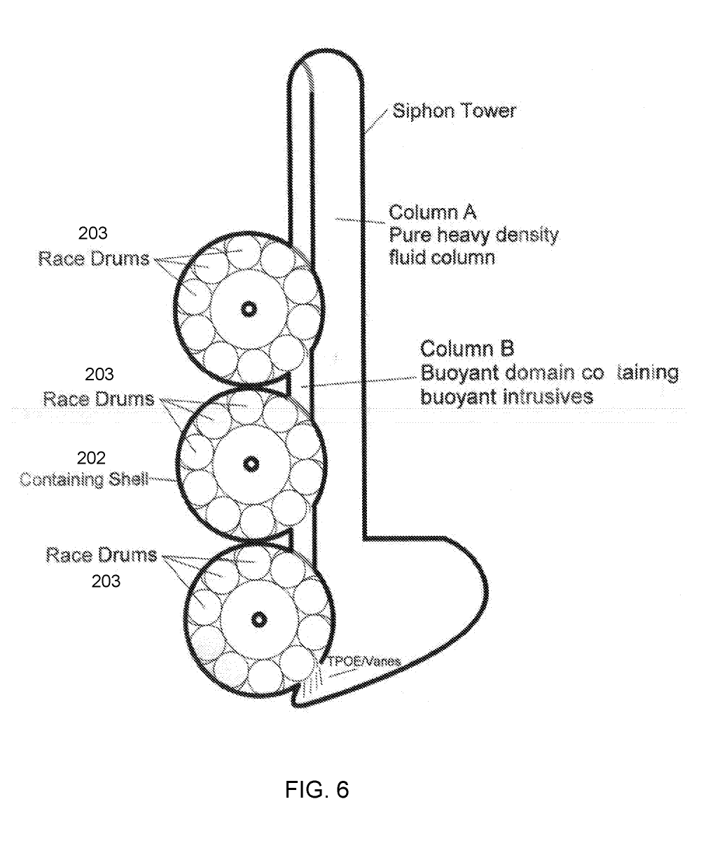

Referring now also to FIG. 6 in the drawings, a side view of a second exemplary configuration using the drum of FIGS. 1A and 1B is illustrated. FIG. 6 illustrates a cross-sectional view where a plurality of RACE systems (i.e. drums) are vertically stacked in order to increase the number of “buoyant intrusives” within the light water column to further reduce the overall weight of this column with respect to the weight of the heavy water column is illustrated. In this embodiment, each drum or RACE system has a unique shaft. It is understood that any number of RACE systems 201 may be combined along a single siphon tower 309. The drums may be aligned in different ways around a central shaft as seen in FIG. 5. In this variation or embodiment multiple shafts are being rotated by a plurality of distinct drums all connected to a singular tank and siphon tower. In this type of configuration, the liquid exiting from one drum body is used to enter an adjacent drum body prior to reaching the siphon tower.

The system in FIG. 6 is a version of system 301 whereby an unlimited number of rotating drums are stacked vertically thus increasing the differential weight between column A and column B. A key feature of system 301 is the ability to maintain separation between the gravitational domain and the buoyancy domain. It is understood that there are numerous methods that may be employed to seal and prevent leakage of the liquid into the dry environment side of drum body 303. FIG. 6 illustrates only one method of doing such action. SIBC's 315 are coupled to each chamber and are configured to a close tolerance so that capillary action limits any leakage between the internal surface of the housing and the drum body 303. The close-fit prevents the passage of liquid around the lower portion of drum body 303 as each mass reaches the TPOE. Additionally, SIBC's 315 are configured to assist in retaining air within the void spaces between each of the masses and the drum body 303. As the mass rotates and reaches the entrance filter, the open void space SIBC 315 permits for the escape of any liquid into siphon tower 309.

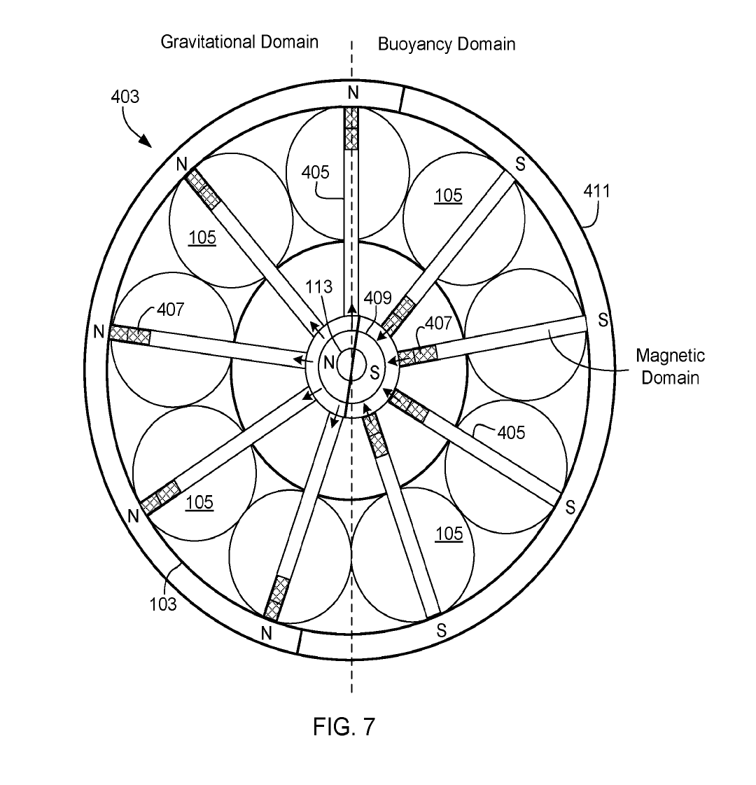

Referring now also to FIG. 7 in the drawings, a cross-sectional side view of the drum of FIGS. 1A and 1B aided with the assistance of a magnetic power amplification (MPA) system 403 is illustrated. MPA 403 can be utilized in either the RCE or the RACE system (101/201) concepts in place of the original buoyancy drum to increase the torque and energy output is illustrated. As stated previously, a magnetic power amplification (MPA) system is designed so that it could replace the original water/air cylinder drum. However, as seen in FIG. 7, such system 403 is also configured to be used in conjunction with a drum of system 101/201. System 403 is used to further amplify the power output of the RCE or RACE units.

This modification is accomplished by the utilization of an MPA drum within a magnetic field, and a fluid containment shell as shown in FIG. 7. The containment shell 413 consists of two powerful fixed-orientation, interfacing, semicircular niobium magnetic halves, with one half being a north pole, and the other half being a south pole. The MPA drum rotates about a fixed-orientation, bipolar, niobium magnetic bar 409 that encircles the axle, but does not rotate with, the axle located at the center of this cavity, and consists of an odd number of buoyant masses with an integral hermetic magnetic sleeve 405 and contain a SIBC chamber thus causing it to rotate continually upwards. The purpose of the “hermetic magnetic sleeves' 405 is to provide a low-friction housing for a niobium magnetic bar 407, or rods, that can be moved inward toward the axle to reduce torque during the rising/upward phase, or outward toward the perimeter to increase torque, and thus power, during the falling/downward phase. Bars 407 are bipolar magnetic rods that have a North pole end and a South pole end. As the drum rotates in a counterclockwise motion, the magnets will be both repelled and attracted simultaneously as the magnetic polarity of the “sleeved” magnetic bars 407 interact with the magnetic axle cover 409 and the peripheral magnetic casing 411. The magnetic bars 407 will be repelled/attracted drawn outwards by unlike north/south poles thus increasing the leverage and resultant torque of the rotating drum in the gravitational domain, and at the same time repelled/attracted inwards toward the center of the rotating drum so as to lessen the buoyant mass to be raised when passing through the buoyant domain.

In consideration of the previous information, it becomes self-evident that the RACE/RCE system concepts do not qualify as perpetual energy for the following reasons:
1. The masses are constantly and rhythmically moving from one media to another, thus continually changing both speed and force with respect to gravity and buoyancy.
2. Each mass is altering its effective mass, with respect to buoyancy, by the employment of SIBCs.
3. This apparatus can convert potential energy into kinetic energy to accomplish useful work.
4. IT derives additional inertial energy as required by a coordinated ancillary device—a flywheel or several out of phase RCEs.

The current application has many advantages over the prior art including at least the following: (1) rotational energy created from rotating masses through a plurality of different domains; (2) inclusion of a siphon effect to increase buoyancy forces; (3) buoyant intrusives to affect the density of fluid and further enhance the buoyancy effect; and (4) inclusion of optional magnetic power amplification system.

It is evident by the foregoing description that the subject application has significant benefits and advantages. The disclosure of the present application is amenable to various changes and modifications without departing from the spirit thereof. The particular embodiments and/or methods disclosed above are illustrative only, as each may be modified and practiced in different but equivalent manners apparent to those skilled in the art having the benefit of the teachings herein. It is therefore evident any alterations, modifications, and all such variations are considered within the scope and spirit of the application. It is apparent that an apparatus with significant advantages has been described and illustrated.

1. A rotary aided conjunctive energy system, comprising:
a housing;
a drum coupled to a shaft and configured to rotate within the housing about a central axis, the central axis concentric with the shaft;
a plurality of enclosed chambers radially aligned around the drum;
wherein the drum is exposed to a gravitational domain and a buoyancy domain simultaneously so as to induce rotation of the drum around the shaft, the enclosed chambers being subjected to gravitational forces in the gravitational domain and the enclosed chambers being subjected to buoyancy forces in the buoyancy domain.

2. The system of claim 1, wherein gravitational forces and buoyancy forces are exerted upon separate enclosed chambers within the drum simultaneously so as to maintain a direction of rotation.

3. The system of claim 1, wherein the shaft is configured to function so as to incorporate a unidirectional ratchet so as to regulate the direction of rotation of the drum.

4. The system of claim 1, wherein the plurality of enclosed chambers are filled with a mixture of air and fluid.

5. The system of claim 4, wherein the ratio of air and fluid may be selectively adjusted.

6. The system of claim 1, further comprising:
a second drum, the drum including a second plurality of chambers, wherein the second drum is exposed to the gravitational domain and the buoyancy domain.

7. The system of claim 6, wherein the second drum is configured to rotate about the shaft with the drum.

8. The system of claim 6, wherein the second drum is configured to include a second shaft.

9. The system of claim 6, wherein the drum and the second drum are configured to share the buoyancy domain.

10. The system of claim 6, wherein the diameter of the drum and the second drum are different so as to vary the amount of torque generated.

11. The system of claim 6, wherein the drum and the second drum are indexed relative to one another.

12. The system of claim 1, further comprising:
a magnetic power amplification system configured to include two fixed orientation magnetic halves that form a casing;
a central magnetic shaft member configured to engage the shaft;
a magnetic sleeve that includes a magnetic rod;
wherein the magnetic rod is selectively moved inward and outward between the shaft and the casing as the drum rotates so as to adjust the amount of torque.

13. The system of claim 12, wherein the rods are transitioned outward in the gravitational domain.

14. The system of claim 12, wherein the rods are transitioned inward in the buoyancy domain.

15. The system of claim 1, further comprising:
a volume of fluid in communication with the drum.

16. The system of claim 15, further comprising:
a buoyant intrusive within the fluid to selectively adjust the fluid density, the density of the fluid being diversified within the volume of fluid.

17. The system of claim 15, further comprising:
a directional vane configured to direct the flow of fluid into the drum.

18. The system of claim 1, further comprising:
a siphon tower to increase the hydraulic force circulating through the drum, the siphon tower holding a volume of fluid, the siphon tower configured to create a column weight differential so as to induce a siphon action and a subsequent rotation of the drum.

19. The system of claim 1, wherein the housing is a tank that is partitioned to create the buoyancy domain and the gravitational domain within the housing.

20. The system of claim 19, wherein the housing includes a seal to prevent the passage of fluid in the buoyancy domain from entering the gravitational domain, the seal in communication with a portion of the drum.

21. The system of claim 19, wherein the housing is used to divide the domains from one another.

22. The system of claim 1, wherein the housing is self-sealed tankless enclosure configured to encapsulate the drum within a single volume of air, the housing including an entry port and an exit port to permit fluid to enter and exit the drum.

23. The system of claim 22, wherein the drum is toleranced so as to provide a seal around an internal surface of the housing thereby preventing the passage of fluid into the drum.
